(19) United States
(12) Patent Application Publication
(10) Pub. No.: US 2015/0143340 A1
(43) Pub. Date: May 21, 2015

(54) METHOD OF CLASSIFYING APPLICATION IN ANDROID OPERATING SYSTEM AND COMPUTER-READABLE RECORDING MEDIUM HAVING PROGRAM FOR CLASSIFYING APPLICATION IN ANDROID OPERATING SYSTEM RECORDED THEREON

(71) Applicant: Korea Advanced Institute of Science and Technology, Daejeon (KR)

(72) Inventors: Insik Shin, Daejeon (KR); Hyosu Kim, Daejeon (KR)

(73) Assignee: Korea Advanced Institute of Science and Technology, Daejeon (KR)

(21) Appl. No.: 14/000,893

(22) PCT Filed: Jan. 24, 2013
(86) PCT No.: PCT/KR2013/000557

§ 371 Date: Aug. 22, 2013

(30) Foreign Application Priority Data
Mar. 12, 2012 (KR) 10-2012-0024968

(51) Int. Cl. G06F 11/30

(52) U.S. Cl. CPC G06F 11/302; G06F 11/3013; G06F 11/3051
USPC 717/124

(57) ABSTRACT

A method of classifying an application in an Android operating system includes analyzing system service performed by a system service module in advance, the system service module being basically mounted to provide core functions of a system in the Android operating system, recognizing a relationship between the application and the system service in the Android operating system, estimating a characteristic of the application based on the relationship between the application and the system service in the Android operating system recognized in the recognizing of the relationship, and classifying the application based on the characteristic of the application estimated by the Android operating system in the estimating of the characteristic.

### CROSS REFERENCE TO PRIOR APPLICATIONS

This application is a National Stage Patent Application of PCT International Patent Application No. PCT/KR2013/000557 (filed on Jan. 24, 2013) under 35 U.S.C. §371, which claims priority to Korean Patent Application No. 10-2012-0024968 (filed on Mar. 12, 2012), which are all hereby incorporated by reference in their entirety.

### TECHNICAL FIELD

The following description relates to a method of classifying an application in an Android operating system and a computer-readable recording medium having a program for classifying an application in an Android operating system recorded thereon.

This work was supported by the IT R&D program of MOTIE (Ministry of Trade, Industry and Energy) and KEIT (Korea Evaluation Institute of Industrial Technology) in Korea[10041313, UX-oriented Mobile SW Platform].

### BACKGROUND ART

In recent years, use of smartphones is sharply increasing. In the smartphones, performance of hardware such as a central processing unit (CPU), a main memory, and an input/output device (I/O device) is limited, unlike desktop computers. When a number of applications operate, the respective applications compete for limited hardware resources, thereby degrading entire performance of applications. Therefore, in an operating system for a smartphone, efficient management of resources is a matter of primary concern.

In an Android operating system recently widely used worldwide, a foreground application is classified into a user interaction application and a background application is classified into a non-interactive application. In the Android operating system, the user interaction application has a high share of the central processing unit or is stored for a longer time in the main memory.

### DISCLOSURE

### Technical Problem

Even though applications can be simply identified as either a foreground application or background ones, it is generally hard to characterize the performance or QoS (quality-of-service) requirements of applications correctly. For example, a music playback application is mainly executed in the background, but the music playback application must seamlessly play music for a user. However, in a conventional method, since the music playback application is classified into a non-interaction application, it would not be given a high priority in resource allocation.

The following description provides a method of classifying an application in an Android operating system and a computer-readable recording medium having a program for classifying an application in an Android operating system recorded thereon, capable of effectively managing applications by classifying the applications according to their characteristics in the Android operating system.

### Technical Solution

In one general aspect, there is provided a method of classifying an application in an Android operating system, wherein the Android operating system is mounted in an embedded device to manage the entire device, and a system service module for performing one or more system services is mounted in the Android operating system to perform one or more core functions of a system, the method including: analyzing the system service performed by the system service module in advance, the system service module being basically mounted to provide the core functions of the system in the Android operating system; recognizing a relationship between the application and the system service in the Android operating system; estimating a characteristic of the application based on the relationship between the application and the system service in the Android operating system recognized in the recognizing of the relationship; and classifying the application based on the characteristic of the application estimated by the Android operating system in the estimating of the characteristic.

In another aspect, there is provided a computer-readable recording medium having a program of classifying an application in an Android operating system stored therein, wherein the Android operating system is mounted in an embedded device to manage the entire device, and a system service module for performing one or more system services is mounted in the Android operating system to perform one or more core functions of a system, the Android operating system including: a pre-analysis module that analyzes system service performed by the system service module in advance, the system service module being basically mounted to provide the core functions of the system; a relationship recognition module that recognizes a relationship between the application and the system service; a characteristic estimation module that estimates a characteristic of the application based on the relationship between the application and the system service recognized in the relationship recognition module; and an application classification module that classifies the application based on the characteristic of the application estimated by the characteristic estimation module.

### Advantageous Effects

With the method of classifying an application in an Android operating system and the recording medium having a program for classifying an application in an Android operating system recorded thereon to be readable by a computer, which will be described below, the applications can be classified according to their characteristics in the Android operating system.

With the method of classifying an application in an Android operating system and the recording medium having a program for classifying an application in an Android operating system recorded thereon to be readable by a computer, which will be described below, system services are analyzed in advance to monitor whether a specific application uses a core function of a system or requests the system service module for termination in order to terminate the use after the system is driven. Accordingly, with the technology that will be described below, it is possible to effectively recognize the relationship between the application and the system service in the Android operating system.

With the method of classifying an application in an Android operating system and the recording medium having a program for classifying an application in an Android operating system recorded thereon to be readable by a computer, which will be described below, it is possible to more accurately classify an application into a user interaction application or a non-user interaction application using an application movement between a foreground and a background.

### DESCRIPTION OF DRAWINGS

FIG. 1 illustrates an example of a configuration of a user terminal in which a method of classifying an application in an Android operating system is performed.

FIG. 2 illustrates an example of a flowchart illustrating a process in which a new relationship is recognized and classification is performed in the method of classifying an application in an Android operating system.

FIG. 3 illustrates an example of a flowchart in which classification is performed according to a change in a state of an application in an application state monitoring module in the method of classifying an application in an Android operating system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### MODES FOR THE INVENTION

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

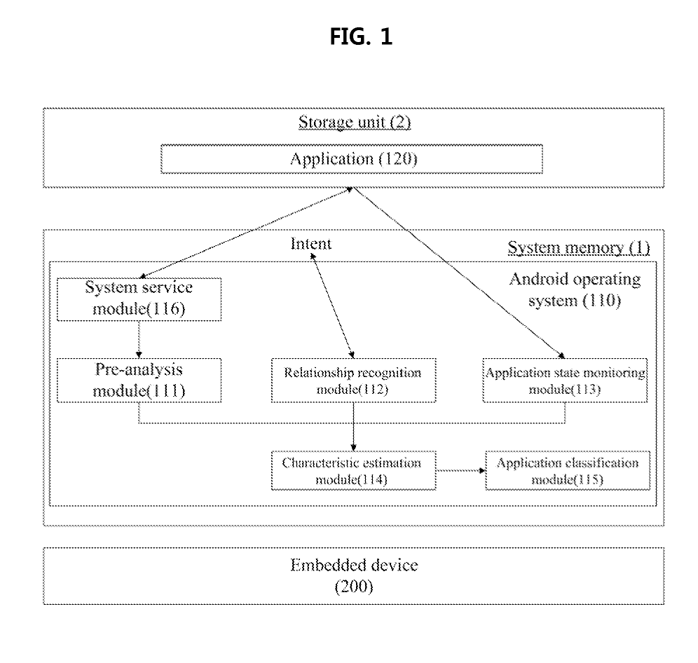

FIG. 1 is a diagram illustrating a configuration of a user terminal in which a method of classifying an application in an Android operating system according to an embodiment of the present invention is performed. Referring to FIG. 1, the user terminal in which a method of classifying an application in an Android operating system according to the present invention is performed includes an Android operating system 110, an application 120 and an embedded device 200.

Here, the Android operating system 110 may be implemented on a system memory 1, and the application 120 may be stored in a storage unit 2. Here, the storage unit 2 is a nonvolatile memory (NVM) in which stored data is continuously held and is not deleted even when a supply voltage is not supplied and may include a flash memory, an MRAM (Magnetic Random Access Memory), a PRAM (Phase-change Random Access memory), an FRAM (Ferroelectric RAM) or the like. Meanwhile, the Android operating system 110 manages the embedded device 200.

More specifically, the Android operating system 110 includes a pre-analysis module 111, a relationship recognition module 112, an application state monitoring module 113, a characteristic estimation module 114, an application classification module 115, and a system service module 116.

The pre-analysis module 111 analyzes a type of a task performed by the system service module 116, which has been basically registered in the Android operating system 110, and a relationship with a user in advance, and stores a value of a result of the analysis. Here, the pre-analysis may be performed upon system booting or prior to installation of the Android operating system 110.

The relationship recognition module 112 recognizes a relationship between the application 120 and the system service module 116. Here, the relationship between the application 120 and the system service module 116 may be recognized by analyzing intent that the application 120 requests the system service module 116 to provide in order to perform a core function of a system. Here, when establishment and breaking of a new relationship is recognized, the relationship recognition module 112 notifies the characteristic estimation module 114 of such a fact.

The application state monitoring module 113 monitors a change in a state of the application 120. Here, the change in a state of the application 120 may be calculated based on a change in a current position. In other words, it is determined that the state of the application 120 is changed when the application 120 is changed from a foreground to a background or from the background to the foreground. Also, when a change in a state of a new application 120 is recognized, the application state monitoring module 113 notifies the characteristic estimation module 114 of such a change.

The characteristic estimation module 114 estimates a characteristic of the application 120 based on the new relationship or a result of a determination as to the change in a state of the application 120 from the relationship recognition module 112 or the application state monitoring module 113. Here, the characteristic estimation module 114 causes the application 130 whose new relationship has been discovered by the relationship recognition module 112 to succeed to a characteristic of the system service performed by the related system service module 116, and estimates the characteristic.

Further, for the application 120 whose relationship with any system service module 116 is recognized by the relationship recognition module 112, the characteristic estimation module 114 estimates the characteristic according to the change in a state of the application 120. For example, the characteristic estimation module 114 estimates the characteristic by determining that the application 120 is closely related to a user when operating in the foreground and is not closely related to the user when operating in the background.

Further, when a new characteristic of the application 120 is estimated, the characteristic estimation module 114 notifies the application classification module 115 of such a new characteristic. The application classification module 115 classifies the application 120 into a user interaction application or a non-user interaction application according to the characteristic of the application 120 estimated by the characteristic estimation module 114. Here, the application 120 is classified into the user interaction application when the application 120 is closely related to the user as a result of estimating the characteristic of the application and into the non-user interaction application when the application 120 is not closely related to the user.

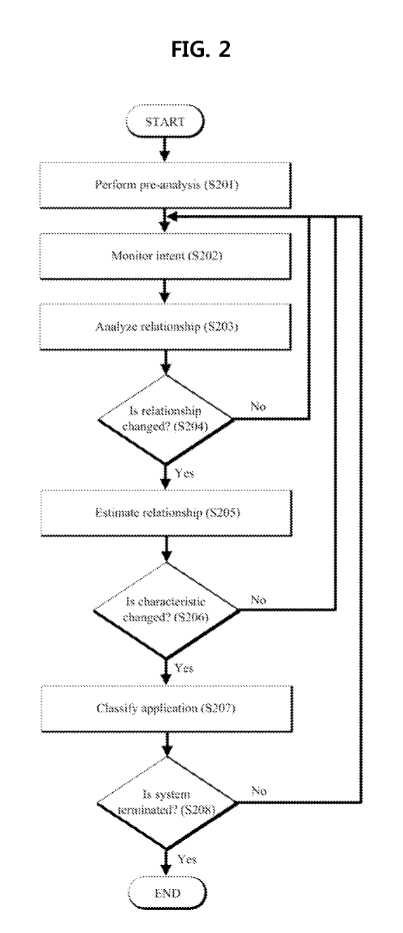

FIG. 2 is a flowchart illustrating a process in which classification is performed when a new relationship is recognized by the relationship recognition module 112 of the present invention. Referring to FIGS. 1 and 2, first, system service is analyzed in advance through the pre-analysis module 111 of the Android operating system 110 (S201).

After the pre-analysis in the pre-analysis module 111 is completed, the Android operating system 110 monitors, using the relationship recognition module 112, whether the application 120 uses a core function of a system or requests the system service module 116 to provide intent in order to terminate the use (S202).

When the relationship recognition module 112 detect the use of the core function of the system by the application 120 or the intent for terminating the use of the core function of the system, which has been requested to the system service module 116, the relationship recognition module 112 analyzes whether the intent is for new use or for stop of the use to analyze a relationship between the application 120 and the system service module 116 (S203).

When the relationship analyzed in step (S203) is a new relationship not present before, the relationship recognition module 112 of the Android operating system 110 notifies the characteristic estimation module 114 of information of the newly recognized relationship (S204). In this case, when the analyzed relationship is the same as a previous relationship, the relationship recognition module 112 returns to step (S202) and iteratively performs steps (S202 to S204) to monitor the intent between the application 120 and the system service module 116.

On the other hand, when it is determined in step (S204) that the new relationship is recognized, the characteristic estimation module 114 causes the application 120 to succeed to the characteristic of the system service module 116 analyzed in step (S201) of performing the pre-analysis, and estimates the characteristic of the application 120 (S205). For example, when the application 120 establishes a relationship with a media server system service performed by the system service module 116 to play a multimedia, a characteristic in which the application 120 performs a task related to the multimedia is estimated, and also a characteristic of the application in which the application has a close relationship with the user in consideration of a characteristic of the multimedia is estimated.

When it is determined in step (S206) that the characteristic of the application 120 is changed as a result of newly estimating the characteristic in step (S205), the characteristic estimation module 114 notifies the application classification module 115 of such a change. On the other hand, when it is determined in step (S206) that there is no change, the process returns to step (S202) so that the relationship recognition module 112 monitors the intent between the application 120 and the system service module 116. When the change in a characteristic of the application 120 is delivered from the characteristic estimation module 114, the application classification module 115 classifies the application 120 into a user interaction application when the application 120 is closely related to the user and into a non-user interaction application when the application 120 is not closely related to the user, based on the changed characteristic (S207).

Finally, after the classification in the application classification module 115 is completed, the process returns to step (S202) so that the relationship recognition module 112 continuously monitors the intent between the application 120 and the system service module 116 when the system still works (S208).

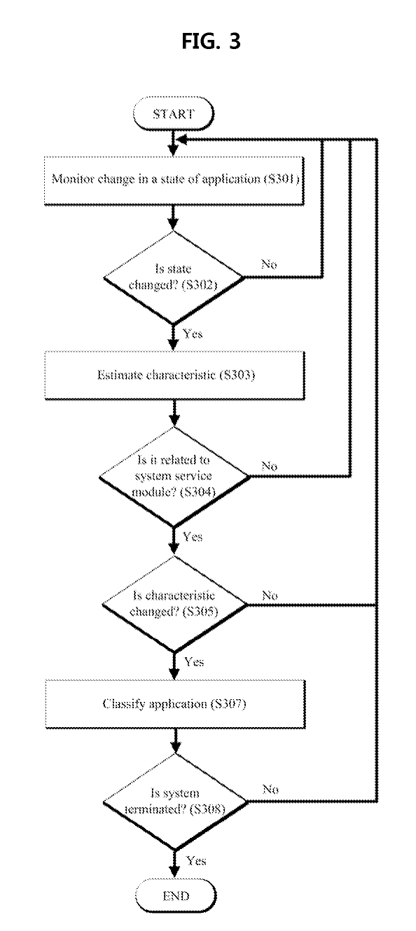

FIG. 3 is a flowchart illustrating a flow in which a change in a state of the application 120 is recognized by the application state monitoring module 113 and classification is performed in a method of classifying an application in an Android operating system according to another embodiment of the present invention. First, when the Android operating system 110 is driven on the system memory 1, the application state monitoring module 113 continuously monitors a change in a state of the application 120 (S301). Here, the change in a state of the application 120 means a change in an operation environment from a foreground to a background or from the background to the foreground.

When the change in a state of the application 120 is detected, the application state monitoring module 113 notifies the characteristic estimation module 114 of such a change (S302).

The characteristic estimation module 114 newly estimates the characteristic of the application 120 based on the change in a state of the application 120 detected in step (S302) by the application state monitoring module 113 (S303). For example, the characteristic estimation module 114 estimates that the application is not closely related to the user when the state is changed from the foreground to the background and that the application is closely related to the user when the state is changed from the background to the foreground. Here, when the characteristic of the application 120 has already been estimated based on the relationship with the system service performed by the system service module 116 in step (S205) of FIG. 2, the characteristic estimation based on the change in a state of the application 120 is omitted and the process returns to step (S301) so that the application state monitoring module 113 monitors the change in a state of the application 120 (S304).

On the other hand, when the characteristic of the application 120 is changed due to the characteristic newly estimated in step (S304), the characteristic estimation module 114 notifies the application classification module 115 of such a change (S305). In this case, when it is determined in step (S305) that there is no change, the process returns to step (S301) so that the application state monitoring module 113 monitors the change in a state of the application 120.

After step (S305), when the change in a characteristic of the application 120 is delivered from the characteristic estimation module 114, the application classification module 115 classifies the application 120 into a user interaction application when the application 120 is closely related to the user or into a non-user interaction application when the application 120 is not closely related to the user, based on the changed characteristic (S306).

Finally, after the classification in the application classification module 115 is completed, the process returns to step (S301) when the user terminal system still works, such that the application state monitoring module 113 monitors the change in a state of the application 120 (S307).

The present invention may be implemented as computer-readable code in a computer-readable recording medium. The computer-readable recording medium includes all types of recording devices in which data that can be read by a computer system is stored.

Examples of the computer-readable recording medium include a ROM, a RAM, a CD-ROM, a magnetic tape, a floppy disk, and an optical data storage device, and also include a recording medium implemented in the form of carrier waves (e.g., transmission through the Internet).

Further, the computer-readable recording medium is distributed to computer systems connected over a network, and computer-readable code may be stored and executed in a distributive manner. Further, a functional program, code and code segments for implementing the present invention can be easily inferred by programmers in a technical field that the present invention belongs to.

While the invention has been shown and described with reference to certain exemplary embodiments thereof, it will be understood by those skilled in the art that various changes in form and details may be made therein without departing from the spirit and scope of the invention as defined by the appended claims.

1. A method of classifying an application in an Android operating system, wherein the Android operating system is mounted in an embedded device to manage the entire device, and a system service module for performing one or more system services is mounted in the Android operating system to perform one or more core functions of a system, the method comprising:
analyzing the system service performed by the system service module in advance, the system service module being basically mounted to provide the core functions of the system in the Android operating system;
recognizing a relationship between the application and the system service in the Android operating system;
estimating a characteristic of the application based on the relationship between the application and the system service in the Android operating system recognized in the recognizing of the relationship; and
classifying the application based on the characteristic of the application estimated by the Android operating system in the estimating of the characteristic.

2. The method according to claim 1, further comprising classifying the application according to a foreground or background state of the application when the relationship between the application and the system service is not recognized in the recognizing of the relationship.

3. The method according to claim 1, wherein:
in the recognizing of the relationship, a structural characteristic that the application requests the system service module to provide in order to use the core functions of the system is used, and
the relationship between the application and the system service is established with one system service or one or more system services.

4. The method according to claim 1, wherein:
the characteristic of the application in the estimating of the characteristic includes the core functions of the system performed by the system service, and a system requirement for performing the core functions of the system; and
the classifying of the application includes the application into a user interaction application or a non-user interaction application based on the requirement.

5. The method according to claim 1, wherein:
when the pre-analysis is completed, the recognizing of the relationship is performed by the Android operating system monitoring whether the application uses the core functions of the system or requests the system service module to provide intent in order to terminate the use.

6. A computer-readable recording medium having a program of classifying an application in an Android operating system stored therein, wherein the Android operating system is mounted in an embedded device to manage the entire device, and a system service module for performing one or more system services is mounted in the Android operating system to perform one or more core functions of a system, the Android operating system comprising:
a pre-analysis module that analyzes system service performed by the system service module in advance, the system service module being basically mounted to provide the core functions of the system;
a relationship recognition module that recognizes a relationship between the application and the system service;
a characteristic estimation module that estimates a characteristic of the application based on the relationship between the application and the system service recognized by the relationship recognition module; and
an application classification module that classifies the application based on the characteristic of the application estimated by the characteristic estimation module.

7. The recording medium according to claim 6, further comprising an application state monitoring module that classifies the application according to a foreground or background state of the application when the relationship between the application and the system service is not recognized.

8. The recording medium according to claim 6, wherein:
the relationship recognition module uses a structural characteristic that the application requests the system service module to provide in order to use the core functions of the system, and
the relationship between the application and the system service is established with one system service or one or more system services.

9. The recording medium according to claim 6, wherein:
the characteristic of the application includes the core functions of the system performed by the system service, and a system requirement for performing the core functions of the system; and
the application classification module classifies the application into a user interaction application or a non-user interaction application based on the requirement.

10. The recording medium according to claim 6, wherein:
the relationship recognition module is performed by the Android operating system monitoring whether the application uses the core function of the system or requests the system service module to provide intent in order to terminate the use when the pre-analysis is completed.
